(19) United States
(12) Patent Application Publication
(10) Pub. No.: US 2014/0039711 A1
(43) Pub. Date: Feb. 6, 2014

(54) DYNAMIC SOURCE BALANCING METHODS AND SYSTEMS

(71) Applicant: Varentec, Inc., San Jose, CA (US)

(72) Inventors: DEEPAKRAJ M. DIVAN, San Jose, CA (US); FRANK KREIKEBAUM, San Jose, CA (US)

(73) Assignee: Varentec, Inc., San Jose, CA (US)

(21) Appl. No.: 13/957,817

(22) Filed: Aug. 2, 2013

Related U.S. Application Data
(60) Provisional application No. 61/679,003, filed on Aug. 2, 2012.

(51) Int. Cl. G06Q 50/06

(52) U.S. Cl. CPC G06Q 50/06
USPC 700/291

(57) ABSTRACT

Dynamic source balancing methods and systems are provided. Power may be provided to a user from one or multiple energy sources. At any time point, the multiple energy sources may have different LMPs and power flow among the energy sources may be controlled such that a user's energy costs are reduced or minimized. Energy arbitrage may be realized for a user by taking into account of various factors related to the energy sources, the power grid, the power market, and/or the user.

### CROSS-REFERENCE TO RELATED APPLICATIONS

This application claims benefit of U.S. Provisional Patent Application No. 61/679,033, filed on Aug. 2, 2012, entitled “Dynamic Source Balancing for Energy Arbitrage,” which is hereby incorporated herein by reference in its entirety.

### TECHNICAL FIELD

The present invention(s) relate generally to controlling power flow in an electric power system. More particularly, the invention(s) relate to dynamic source balancing methods and systems.

### DESCRIPTION OF THE RELATED ART

An electric power system is a network of interconnected electrical equipment that generate, transmit, and consume electric power. Electric power is delivered to consumers through a transmission network and a distribution network from generators to consumers. The transmission network and the distribution network are often known as the transmission grid and the distribution grid, respectively. Operation of the transmission grid and the distribution grid was once straightforward before the deregulation of the electric power market, but became extremely complex as a result of the competition among various utility companies. The potentially competitive functions of generation and retail are separated from the natural monopoly functions of transmission and distribution. Electricity, as a commodity, may be traded in an electricity market. Market players such as generators, retailers, users, and other financial intermediaries may participate in the electricity market both for short-time delivery of electricity and for future delivery periods.

Available resources and demand such as the system loading level may affect the electricity prices, which can vary significantly by location and by time. When system congestion constrains a transmission corridor, significant differences in prices can occur at either end of the transmission line. This variability of pricing is known as the Locational Marginal Pricing (“LMP”). The LMP is the hypothetical incremental cost to the system that would result from the optimized re-dispatch of available units to supply one additional MW of load at the node associated with the LMP. The LMP establishes a hypothetical production cost of the hypothetical Megawatt-hour and becomes the basis for the operation of the electricity market. Some markets also have long-term generation capacity markets. The market players make their decisions based on the LMP, capacity prices, or other similar nodal prices. As the electricity market is highly dynamic, different market players participate in the electricity market differently. For example, larger industrial customers actively participate in the electricity market by scheduling operations and bidding on energy contracts to secure favorable operating costs. Smaller customers are beginning to enjoy the benefits through programs such as ‘time of use metering’, demand response, energy storage and net metering.

### BRIEF SUMMARY OF EMBODIMENTS OF THE INVENTION

According to various embodiments of the invention, dynamic source balancing methods and systems are provided. Various embodiments may provide power to a user from one or multiple energy sources. At any time point, the multiple energy sources may have different LMPs. Various embodiments may control power flow among the energy sources thereby reducing or minimizing a user's energy costs. As such, energy arbitrage may be realized.

In some embodiments, a dynamic source balancer may comprise a control module, which determines the energy sources from which a user obtains power and the amount of power the user obtains from each energy source, at a time point. The control module's determination may be based on various factors related to the energy sources, the power grid, the power market, and/or the user. In one embodiment, the control module may determine the amount of power the user obtains from each respective energy source based on the instantaneous real-time LMPs, the forecasted LMPs of a time point, the user's power consumption, and the user's forecasted power consumption of a time point, the user's contractual terms with each energy source, and/or a demand history for each energy source.

In further embodiments, a dynamic source balancer may comprise an energy routing module, which regulates the amount of power a user receives from each energy source. Various embodiments may provide uninterrupted power supply to a user. In addition, a dynamic power balancer may be protected from overvoltage and may maintain a fast static transfer switch function even when the source balancing capability is lost due to a fault or a failure.

Other features and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

The present invention, in accordance with one or more various embodiments, is described in detail with reference to the following figures. The drawings are provided for purposes of illustration only and merely depict typical or example embodiments of the invention. These drawings are provided to facilitate the reader's understanding of the invention and shall not be considered limiting of the breadth, scope, or applicability of the invention. It should be noted that for clarity and ease of illustration these drawings are not necessarily made to scale.

FIGS. 1a- 1d illustrate prior art configurations for implementing dual source feeds.

FIG. 2 illustrates an exemplary one-line diagram of an electric power system 200 where various embodiments of the invention can be implemented.

FIG. 3 illustrates an exemplary dynamic source balancer, which may be implemented as illustrated in FIG. 2.

FIG. 4 illustrates an exemplary dynamic source balancer, which may be implemented as illustrated in FIG. 2.

FIG. 5 illustrates an exemplary method of controlling a dynamic source balancer, such as for the embodiment illustrated in FIG. 4.

FIG. 6 illustrates an exemplary dynamic source balancer, which may be implemented as illustrated in FIG. 2.

FIG. 7 illustrates an exemplary dynamic source balancer, which may be implemented as illustrated in FIG. 2.

FIG. 8 illustrates an exemplary dynamic source balancer, which may be implemented as illustrated in FIG. 2.

FIG. 9 illustrates an example computing module that may be used in implementing various features of embodiments of the invention.

The figures are not intended to be exhaustive or to limit the invention to the precise form disclosed. It should be understood that the invention can be practiced with modification and alteration, and that the invention be limited only by the claims and the equivalents thereof.

### DETAILED DESCRIPTION OF THE EMBODIMENTS OF THE INVENTION

Energy arbitrage takes advantage of pricing differences of various electricity feeds to reduce or minimize the electricity costs for customers. For example, a customer may negotiate with different electricity sources to determine the source(s) providing the lowest price for the amount of electricity that the user anticipates to consume. The customer may enter into contracts with one or more different energy sources. This approach is nevertheless static and time-consuming. The customer has to forecast the consumption, which may not be accurate. The energy sources determine the prices based on predictions of the consumption prediction and the electricity market, which may not reflect the lowest real-time electricity prices. Furthermore, the energy sources may impose constraints such as the electricity ramp rate, the peak demand, different market rules, and whether deviation from the schedule is permitted. These constraints as well as physical constraints of the power system such as a line's capacity under normal operation and fault conditions, thermal constraints of the system, and system reliability may both affect the ultimate energy costs for the user but are not addressed.

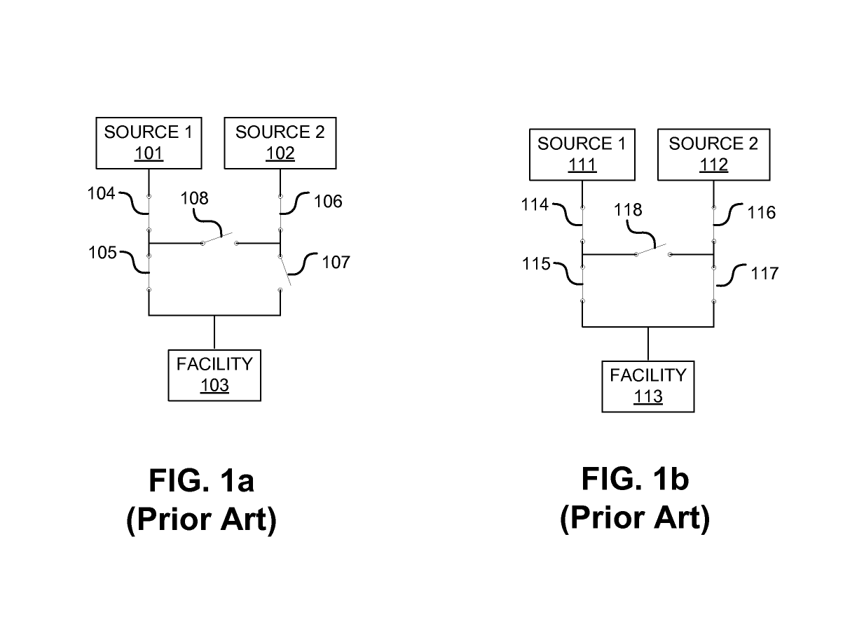

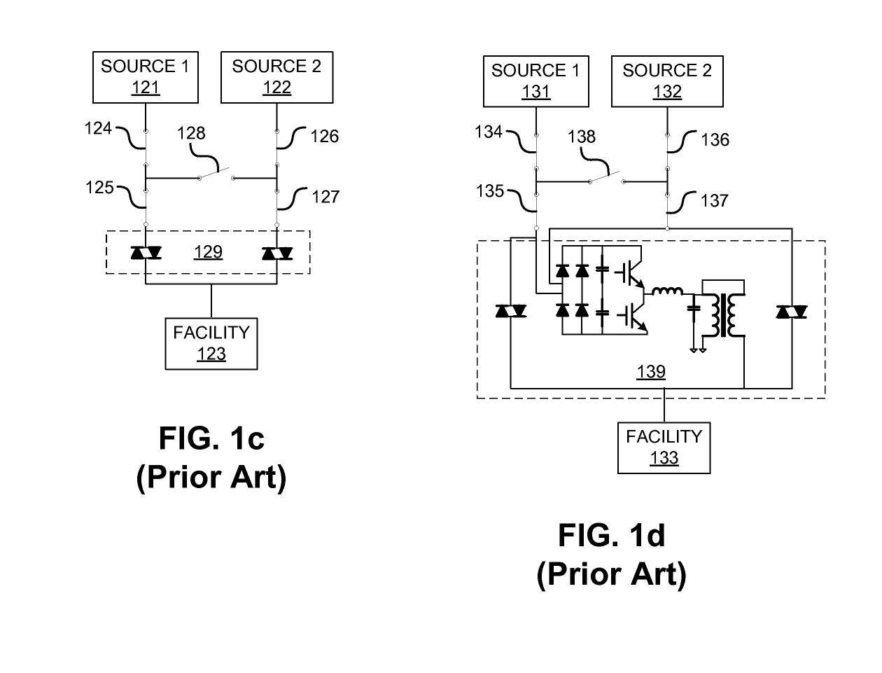

Large industrial customers, such as data centers, large automotive or semiconductor plants, or even large electricity cooperatives, require ultra high levels of reliability in the power supply. These facilities usually use dual electricity feeds from two distinct sources. FIGS. 1a-1d illustrate prior art configurations for implementing dual source feeds. FIGS. 1a illustrates a normally open dual source feed configuration. In the illustrated example, the switches 104-106 are normally closed, whereas the switches 107 and 108 are normally open. As such, the source 101 supplies power to the facility 103. By switching the switches 105-108, power may be supplied from the source 102 or from both the source 101 and 102. FIG. 1b illustrates a normally closed dual source feed configuration. In the illustrated example, the switches 115-117 are normally closed whereas the switch 118 is normally open. As such, the sources 111-112 supply power to the facility 113. By switching the switches 115-118, power may be supplied from the source 111 or the source 112.

FIG. 1c illustrates a static transfer switch dual source feed configuration. In the illustrated example, the switches 124-127 are normally closed whereas the switch 128 is normally open. By switching the switches 124-128 and the static transfer switch 129, power may be supplied from the sources 121 and 122 or switched from the source 121 to 122, or vice versa. Compared to the configurations illustrated in FIGS. 1a and 1b, the power transfer between the sources can be completed more rapidly in the configuration illustrated in FIG. 1c. In addition, the static transfer switch 129 may protect the facility 123 from even a few power frequency cycles interruption time, or from any surges or sags in the power sources 121-122. FIG. 1d illustrates a dynamic sag corrector dual source feed configuration. In the illustrated example, the switches 134-137 are normally closed whereas the switch 138 is normally open. By switching the switches 134-138 and the dynamic sag corrector 139, power may be supplied from the sources 131 and 132 or switched from the source 131 to 132, or vice versa. Compared to the configurations illustrated in FIGS. a-1b, the dynamic sag corrector 139 protects the facility 133 from the voltage sags which may be present when switching between the sources 131 and 132.

Of the dual sources configurations illustrated in FIGS. 1a-1d, one source is a primary source where the facilities obtain the power most of the time, and the other source is the secondary source where the facilities is switched from the primary source only when required. In many cases, facilities may pay to build a line from the secondary sources. The configurations illustrated in FIGS. 1a-1d may allow the facility to receive power from the energy source with the lowest LMP between the two feeds. Further, the configurations illustrated in FIGS. 1c-1d may switch between power sources without causing an interruption of energy delivery to the facilities or causing additional stress to the power grid. However, because real-time LMPs of the dual energy sources can be highly dynamic, the configurations illustrated in FIGS. 1a-1d must switch rapidly to connect the facility to the energy source with the lowest LMP. Such rapid switching between two distinct sources may cause large dynamic load and voltage variations to the power grid. In addition, these configuration lack the ability to dispatch a certain amount of power from a single source to the facility.

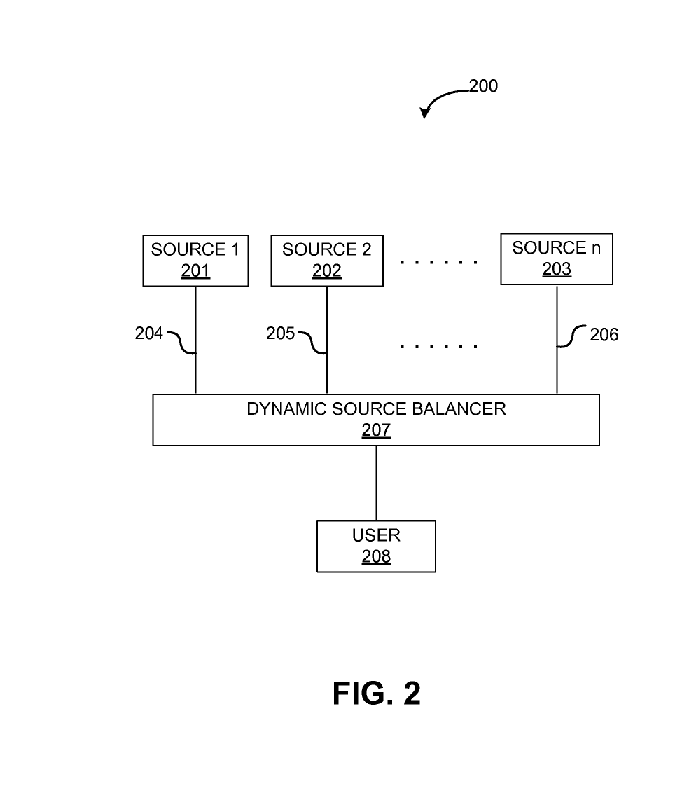

Before describing the invention in detail, it is useful to describe a few example environments with which the invention can be implemented. One such example is that of illustrated in FIG. 2.

FIG. 2 illustrates an exemplary one-line diagram of an electric power system 200 where various embodiments of the invention can be implemented. The electric power system 200 comprises energy sources 1-n 201-203 and feeders 1-n 204-206, which may have different ratings and are loaded differently. As illustrated, an uninterrupted supply of power to the user 209 may be achieved by using multiple (e.g., dual) electricity feeders 204-206 from multiple distinct sources 201-203. These multiple source feeds 201-203 maintain the reliability of the electricity supply for the user 209. A power balancer 207 may be implemented to connect the user 208 to the electric power system 200. Power may be distributed to the user 208 via the feeders 204-206 from the energy sources 201-203. Each of the feeders 204-206 correspond to a LMP. The dynamic source balancer 207 may select at least one of the multiple available energy sources 201-203 and support the entire load of the user 208 by using the source(s) selected. In addition, the dynamic source balancer 207 may determine the amount of power delivered from each energy source and distribute the power to the user accordingly. Furthermore, switching between the sources 201-203 may be controlled such that the user 208 does not experience any interruption of power delivery.

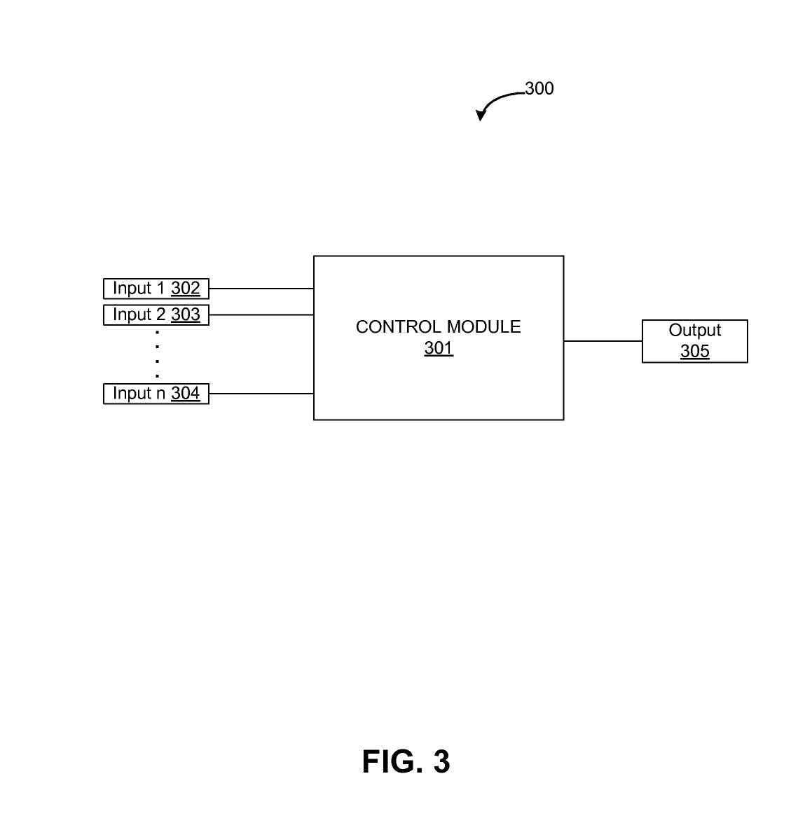

FIG. 3 illustrates an exemplary dynamic source balancer 300, which may be implemented as illustrated in FIG. 2. The dynamic source balancer 300 may provide power needed by a user via dynamic blending of power from multiple distinct energy sources. The illustrated dynamic source balancer 300 comprises a control module. The control module 301 may determine a set of energy sources where the power should be obtained and the amount of power obtained from each energy source. Various embodiments may comprise a power routing module (not shown). The power routing module may operate according to the control module's determination.

The total cost of electricity for a user may be dependent on many factors (e.g., the peak demand charge, a power factor, or the time of use.) In addition, a user may be restricted to a ramp rate limit that prevents random and frequent switchings between sources. In the illustrated example, the control module 301 is provided with a set of inputs 1-n 302-304 and generates an output 304. The set of inputs may describe the user, the real-time market, and the power grid where the user may obtain power from. The set of inputs may comprise the real-time LMP price for each energy source, a forecasted LMP price at a time point for each energy source, a load consumption history for each energy source, a LMP price history for each energy source; the real-time user's power consumption, a forecasted user's power consumption at a time point, a power consumption history of the user, the user's power quality range; the line capacity (e.g., the thermal constraints, the fault components) for each feeder, the ramp rate limit for each energy source, the demand tariff for each energy source, the peak demand for each energy source; the market rules; or whether deviation from a delivery schedule is permitted.

The control module 301 may determine the amount of power the user obtains from each energy source at a time point based on a cost function and the set of inputs 302-304. The output 305 may include the control module's determination and may indicate the fraction of demand to be supplied from each source. The control module 301 may minimize a desired cost function such as the minimum cost of energy for the user. For example, if one energy source has a lower LMP than another energy source, but the power demand of the one energy source would exceed the previous peak demand on that feeder for that one energy source, then the dynamic source balancer determines the user obtains some power from the energy source with the higher LMP source. Accordingly, the overall cost of energy for a user may be dramatically reduced because the user can obtain power from multiple energy sources according to the real-time LMP and other factors. Some embodiments may provide at least a 17% net reduction in energy cost over a year for a multi-MW facility supplied by substations with an average LMP differences of less than 5%.

The dynamic source balancer 300 may comprise a power routing module (not shown). The power routing module may dispatch power to a user according to the control module's determination. The power routing module may be capable of regulating power flows among energy source or transmission or distribution lines. The dynamic source balancer 300 (e.g., the control module 301) may generate a set of commands based on the output 305 and provide the set of commands to the power routing module. In some embodiments, the dynamic source balancer 300 may comprise a communication module (not shown) that transmits the output 305 to one or more devices.

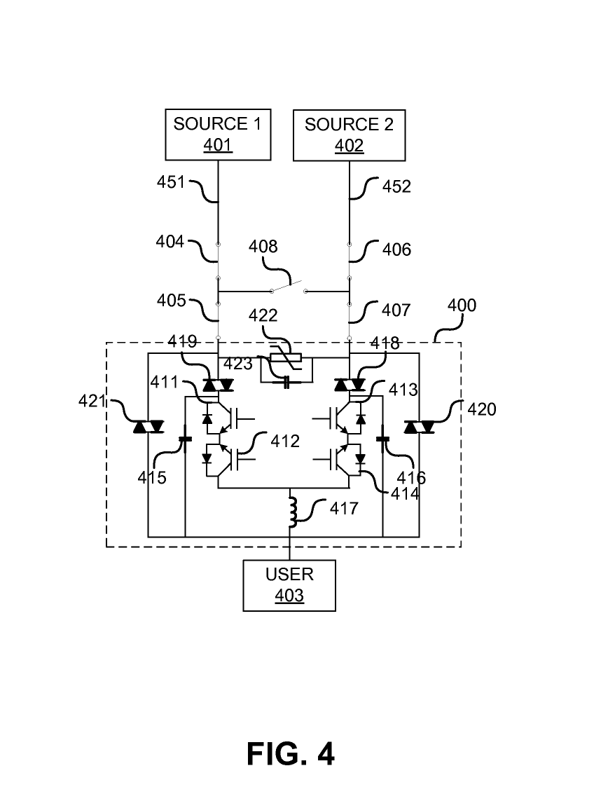

FIG. 4 illustrates an exemplary dynamic source balancer 400, which may be implemented as illustrated in FIG. 2. The illustrated dynamic source balancer 400 comprises a control module (not shown), AC switches 411-414, an LC filter comprising capacitors 415-416 and an inductor 417, AC switches 418-419, a static transfer switch comprising AC switches 420-421, and a metal-oxide varistor (MOV) 422 and a capacitor 423. As the phase angle difference between adjacent feeders 451 and 452 is generally less than five degrees, the peak voltage experienced by any device that spans across feeders 451-452 is limited. The control module may control the duty cycle of the AC switches 411-414 thereby controlling the amount of current drawn from the feeders 451 and 452. Accordingly, the amount of power obtained from the energy sources 401 and 402 are controlled.

The control module may determine the amount of power to be obtained from each feeder 451 or 452 at a time point. This determination may be based on a set of inputs describing the energy sources 401-402, the feeders 451-452, the user 403, and/or the power market to which the user 403 participates and a cost function. In various embodiments, a set of switching commands may be determined and provided to AC switches 411-414 and 418-421.

The AC switches 411-414 may switch at a high frequency (e.g., 1-20 kHz). The LC filter comprising the capacitors 415-416 and the inductor 417 may reduce the switching noise caused by the AC switches 411-414. In various embodiments, the AC switches 411-414 are switches that conduct currents in both directions and block voltages in both directions. In some embodiments, insulated-gate bipolar transistors (IGBTs) with an antiparallel diode or metal-oxide-semiconductor field-effect transistor (MOSFETs) with an antiparallel diode may be used. One of ordinary skill in the art should appreciate that switches 411-414 may be implemented by other devices.

The AC switches 418-419 may protect the dynamic source balancer 400 from high voltage stresses. High voltage may appear across the AC switches 411-414 when the phase angle between the sources 401-402 increases dynamically. For example, this may occur during system faults or system reconfigurations. In various embodiments, each of the AC switches 418-419 is a pair of thyristors. The pair of thyristors are connected such that the anode of one thyristor is connected to the cathode of the other thyristor. The AC switches 418-419 may support the full voltage and carry the full current, but cannot be switched at a high frequency. When the AC switches 411-414 are turned off under a high voltage condition, the AC switches 418-419 may block the voltages. This transition may be controlled to last only a short period of time such that the AC switches 411-414 are protected from the overvoltages.

The AC switches 420-421 ensure the user 403 receives uninterrupted power supply from the energy sources 401 and 402. When the AC switches 411-414 are turned off, the AC switches 420-421 may provide a fast bypass to ensure that the load remains connected to either the energy source 401 or the energy source 402. The AC switches 420-421 may also provide a path for high currents caused by downstream faults. In various embodiments, each of the AC switches 420-421 is a pair of thyristors. The pair of thyristors are connected such that the anode of one thyristor is connected to the cathode of the other thyristor. The AC switches 410-421 are rated for high fault currents and may be coordinated with downstream devices such as switchgears and fusings.

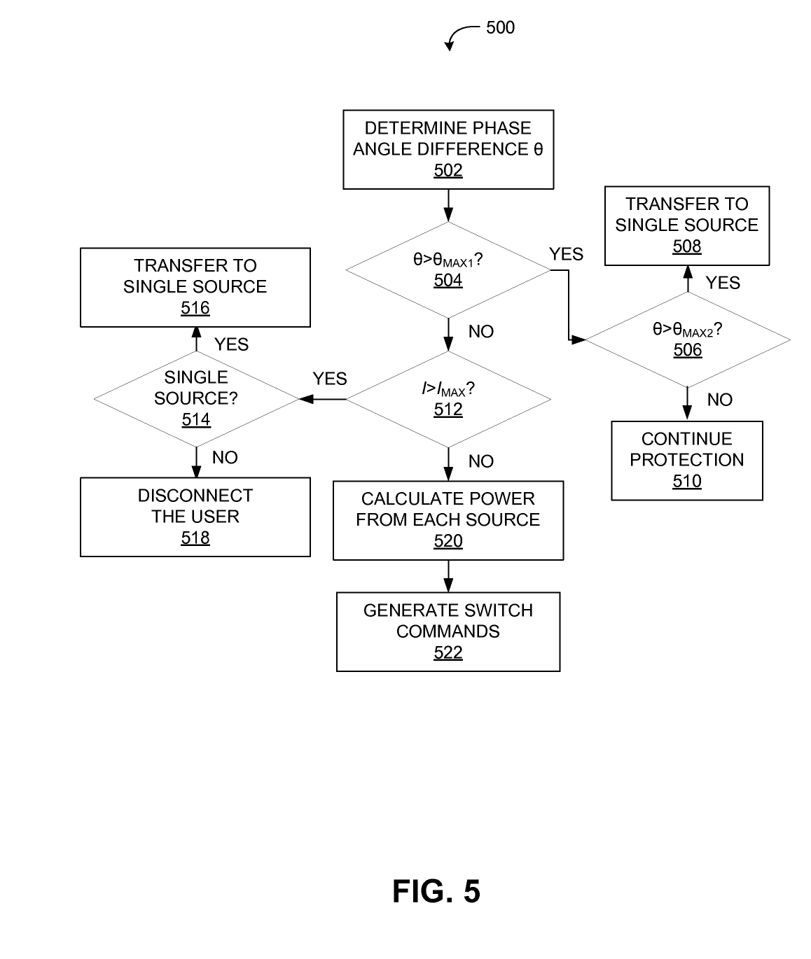

FIG. 5 illustrates an exemplary method 500 of controlling a dynamic source balancer, such as for the embodiment illustrated in FIG. 4. At step 502, a phase angle difference θ between two adjacent energy sources is determined. In various embodiments, a set of phase angle differences may be determined when there are more than two energy sources. At step 504, each phase angle difference is compared to the phase angle limit θ_{MAX1} of a dynamic source balancer. If a phase angle difference is determined to exceed the phase angle limit θ_{MAX1} of the dynamic source balancer, at step 506, the phase angle difference is compared to the phase angle limit θ_{MAX2} of a static transfer switch. If the phase angle difference is determined to exceed the phase angle limit θ_{MAX2} of a static transfer switch, at step 508, a single energy source is identified for supplying the user and the static transfer switch is switched accordingly. If the phase angle difference does not exceed the phase angle limit θ_{MAX2} of a static transfer switch, at step 510, no static transfer switch is determined to switch and continues to protect the dynamic source balancer.

If the phase angle difference does not exceed the phase angle limit θ_{MAX1} of the dynamic source balancer, at step 512, the current I through the dynamic source balancer is compared to the current limit I_{MAX} of the dynamic source balancer. A fault may cause the current through a dynamic source balancer to exceed the current limit of the dynamic source balancer. At step 514, upon determining that the current I exceeds the current limit I_{MAX} of the dynamic source balancer, whether the fault location allows a single source supply of energy is determined. At step 516, the user is transferred to the appropriate energy source if the fault location allows a single source supply of energy. At step 518, the user is disconnected from a grid if the fault location disallows a single source supply of energy.

At step 520, if the current I through the dynamic source balancer does not exceed the current limit I_{MAX} of the dynamic source balancer, the amount of energy drawn from each energy source is determined. Subsequently, a set of switching commands is generated based on the determination of step 520, and the dynamic source balancer is switched accordingly such that the user draws a predetermined amount of energy from each energy source thereby minimizing the energy cost.

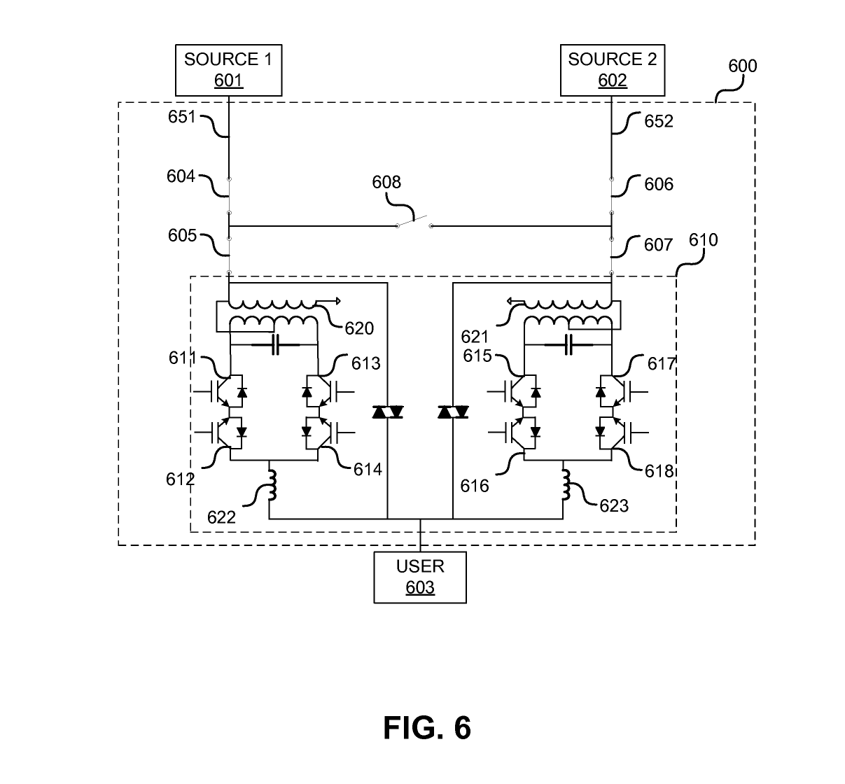

FIG. 6 illustrates an exemplary dynamic source balancer 600, which may be implemented as illustrated in FIG. 2. The illustrated dynamic source balancer comprises an energy routing module 610. The energy routing module 610 may regulate power flow including reactive and active power flows among various lines of a power grid. The illustrated energy routing module 610 comprises transformers 620-621, AC switches 611-618, and inductors 622-623. In various embodiments, the transformers 620-621 are auto-transformers. The voltage stress across the AC switches 611-618 are constrained and not affected by the energy sources. As a result, the AC switches 611-618 no longer need to be monitored for accidental overvoltages.

In various embodiments, the switches 611-614 may be operated according to a first duty cycle D1 and the switches 615-618 may be operated according to a second duty cycle D2. The first duty cycle D1 and the second duty cycle D2 determine the amount of energy supplied by the energy sources 601 and 602, respectively. The dynamic source balancer 600 may determine the amount of power to be supplied from each of the energy sources. By controlling the switches 611-618, in the illustrated example, the desired source balancing between the sources 601 and 602 are realized. Further embodiments may comprise a fault mode bypass and coordination similar to the illustration of FIG. 4.

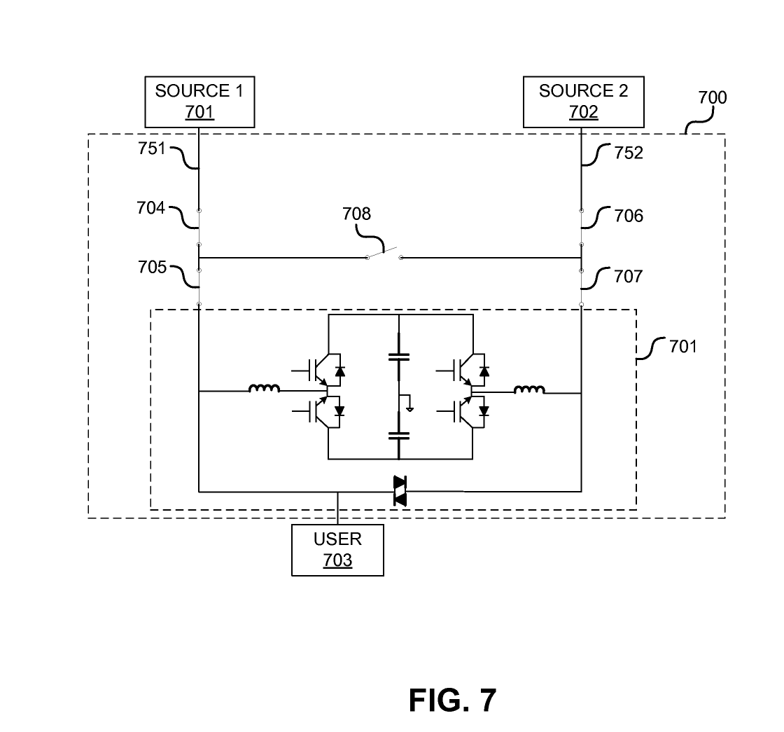

FIG. 7 illustrates an exemplary dynamic source balancer 700, which may be implemented as illustrated in FIG. 2. The illustrated dynamic source balancer 700 comprises a back-to-back (“BTB”) converter 701. One of ordinary skill in the art will appreciate that other AC-AC converters may be implemented similar to the BTB converter 701.

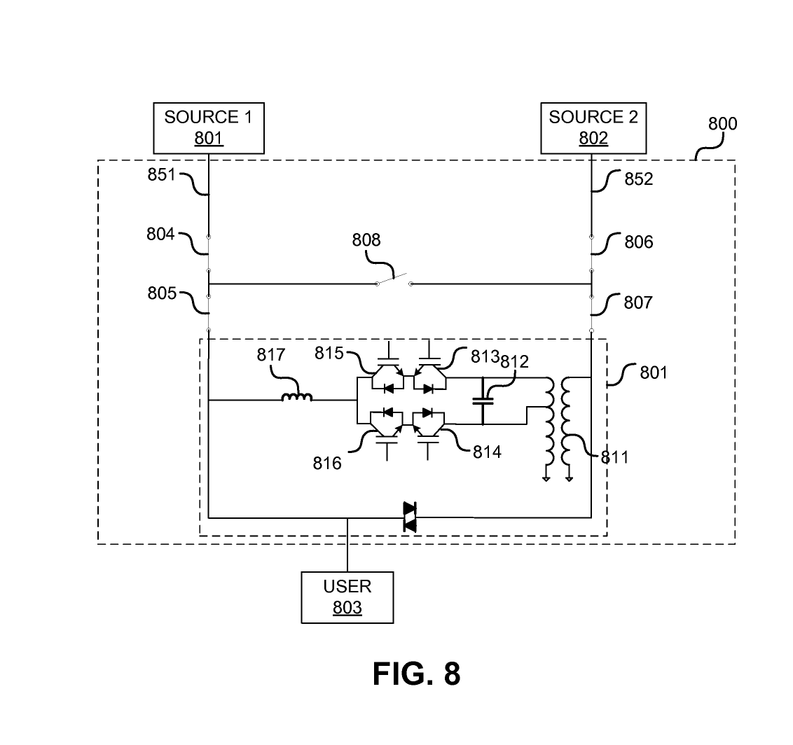

FIG. 8 illustrates an exemplary dynamic source balancer 800, such as the embodiment illustrated in FIG. 2. The illustrated dynamic source balancer 800 comprises a Controllable Network Transformer (“CNT”) 801. The CNT 801 comprises a transformer 811 and a converter comprising a capacitor 812, AC switches 813-816 and an inductor 817. The converter is fractionally rated and the CNT 801 may provide a wide range of power flow control. The dynamic source balancer 800 may comprise a control module (not shown) determining the amount of power to be supplied from each of the energy sources. In various embodiments, the control module may implement the Virtual Quadrature Sources (VQS) (described in the U.S. Pat. No. 8,179,702, entitled “Voltage Synthesis Using Virtual Quadrature Sources”) as the modulation strategy. As such, the effective LMP for the user 803 may be controlled. Further, the exchange of power between various different LMP locations may be facilitated, thereby enabling additional revenue streams, where energy delivered from the lower LMP point to the higher LMP point can be monetized. One of ordinary skill in the art will understand that a dynamic source balancer may comprise other fractionally-rated devices with power flow control capabilities such as a compact dynamic phase angle regulator (CD-PAR) (described in the U.S. patent application Ser. No. 13/707,558, filed on Dec. 6, 2012 and entitled “Compact Dynamic Phase Angle Regulators.”)

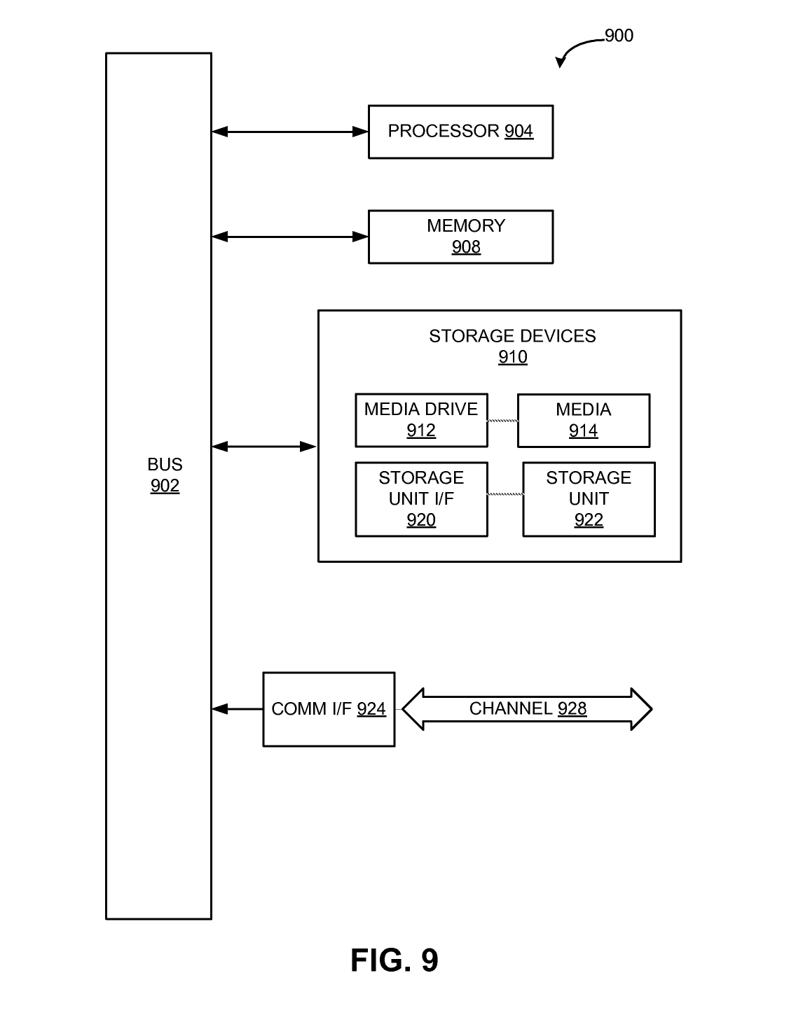

As used herein, the term module might describe a given unit of functionality that can be performed in accordance with one or more embodiments of the present invention. As used herein, a module might be implemented utilizing any form of hardware, software, or a combination thereof. For example, one or more processors, controllers, ASICs, PLAs, PALs, CPLDs, FPGAs, logical components, software routines or other mechanisms might be implemented to make up a module. In implementation, the various modules described herein might be implemented as discrete modules or the functions and features described can be shared in part or in total among one or more modules. In other words, as would be apparent to one of ordinary skill in the art after reading this description, the various features and functionality described herein may be implemented in any given application and can be implemented in one or more separate or shared modules in various combinations and permutations. Even though various features or elements of functionality may be individually described or claimed as separate modules, one of ordinary skill in the art will understand that these features and functionality can be shared among one or more common software and hardware elements, and such description shall not require or imply that separate hardware or software components are used to implement such features or functionality.

Where components or modules of the invention are implemented in whole or in part using software, in one embodiment, these software elements can be implemented to operate with a computing or processing module capable of carrying out the functionality described with respect thereto. One such example computing module is shown in FIG. 9. Various embodiments are described in terms of this example-computing module 900. After reading this description, it will become apparent to a person skilled in the relevant art how to implement the invention using other computing modules or architectures.

Referring now to FIG. 9, computing module 900 may represent, for example, computing or processing capabilities found within desktop, laptop and notebook computers; hand-held computing devices (PDA's, smart phones, cell phones, palmtops, etc.); mainframes, supercomputers, workstations or servers; or any other type of special-purpose or general-purpose computing devices as may be desirable or appropriate for a given application or environment. Computing module 900 might also represent computing capabilities embedded within or otherwise available to a given device. For example, a computing module might be found in other electronic devices such as, for example, digital cameras, navigation systems, cellular telephones, portable computing devices, modems, routers, WAPs, terminals and other electronic devices that might include some form of processing capability.

Computing module 900 might include, for example, one or more processors, controllers, control modules, or other processing devices, such as a processor 904. Processor 904 might be implemented using a general-purpose or special-purpose processing engine such as, for example, a microprocessor, controller, or other control logic. In the illustrated example, processor 904 is connected to a bus 902, although any communication medium can be used to facilitate interaction with other components of computing module 900 or to communicate externally.

Computing module 900 might also include one or more memory modules, simply referred to herein as main memory 908. For example, preferably random access memory (RAM) or other dynamic memory, might be used for storing information and instructions to be executed by processor 904. Main memory 908 might also be used for storing temporary variables or other intermediate information during execution of instructions to be executed by processor 904. Computing module 900 might likewise include a read only memory (“ROM”) or other static storage device coupled to bus 902 for storing static information and instructions for processor 904.

The computing module 900 might also include one or more various forms of information storage mechanism 910, which might include, for example, a media drive 912 and a storage unit interface 920. The media drive 912 might include a drive or other mechanism to support fixed or removable storage media 914. For example, a hard disk drive, a floppy disk drive, a magnetic tape drive, an optical disk drive, a CD or DVD drive (R or RW), or other removable or fixed media drive might be provided. Accordingly, storage media 814 might include, for example, a hard disk, a floppy disk, magnetic tape, cartridge, optical disk, a CD or DVD, or other fixed or removable medium that is read by, written to or accessed by media drive 912. As these examples illustrate, the storage media 914 can include a computer usable storage medium having stored therein computer software or data.

In alternative embodiments, information storage mechanism 910 might include other similar instrumentalities for allowing computer programs or other instructions or data to be loaded into computing module 900. Such instrumentalities might include, for example, a fixed or removable storage unit 922 and an interface 920. Examples of such storage units 922 and interfaces 920 can include a program cartridge and cartridge interface, a removable memory (for example, a flash memory or other removable memory module) and memory slot, a PCMCIA slot and card, and other fixed or removable storage units 922 and interfaces 920 that allow software and data to be transferred from the storage unit 922 to computing module 900.

Computing module 900 might also include a communications interface 924. Communications interface 924 might be used to allow software and data to be transferred between computing module 900 and external devices. Examples of communications interface 924 might include a modem or softmodem, a network interface (such as an Ethernet, network interface card, WiMedia, IEEE 802.XX or other interface), a communications port (such as for example, a USB port, IR port, RS232 port Bluetooth® interface, or other port), or other communications interface. Software and data transferred via communications interface 924 might typically be carried on signals, which can be electronic, electromagnetic (which includes optical) or other signals capable of being exchanged by a given communications interface 924. These signals might be provided to communications interface 924 via a channel 928. This channel 928 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to media such as, for example, memory 908, storage unit 920, media 914, and channel 928. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing module 900 to perform features or functions of the present invention as discussed herein.

While various embodiments of the present invention have been described above, it should be understood that they have been presented by way of example only, and not of limitation. Likewise, the various diagrams may depict an example architectural or other configuration for the invention, which is done to aid in understanding the features and functionality that can be included in the invention. The invention is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the present invention. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the invention is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus, the breadth and scope of the present invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A computer-implemented method of supplying power to a user from energy sources, comprising:
receiving a set of inputs describing a set of energy sources, a power system, a power market, and the user;
defining a cost function; and
determining an amount of power supplied from each energy source of the set of energy sources according to the set of inputs and the cost function.

2. The method of claim 1, wherein the set of inputs comprises a real-time locational marginal pricing (“LMP”) for each energy source of the set of energy sources, a forecasted LMP for each energy source at a time point, a load consumption history for each energy source, a LMP price history for each energy source, a real-time user's power consumption, a forecasted user's power consumption at a time point, a power consumption history for the user, a user's power quality range, or a set of constraints.

3. The method of claim 2, wherein the set of constraints comprises a line capacity for each feeder of a set of feeders, a ramp rate limit for each energy source, a demand tariff for each energy source, a peak demand for each energy source, or a market rule, wherein each feeder of the set of feeders is configured to be coupled to an energy source of the set of energy sources.

4. The method of claim 1, further comprising controlling the power supplied to the user such that each energy source supplies the amount determined.

5. The method of claim 4, wherein the step of controlling the power comprises generating and executing a set of commands to control the power flow among the set of energy sources and the user.

6. The method of claim 1, further comprising monitoring a phase angle difference between two adjacent feeders of a set of feeders, wherein each feeder of the set of feeders is coupled to an energy source of the set of energy sources.

7. The method of claim 6, further comprising connecting the user to a second set of energy sources of the first set of energy sources when the phase angle difference exceeds a predetermined value.

8. The method of claim 1, further comprising monitoring a current supplied to the user.

9. The method of claim 8, further comprising disconnecting the user when the current exceeds a predetermined value.

10. A system of supplying power to a user from a set of energy sources, comprising:
a control module, the control module is configured to:
receive a set of inputs describing a set of energy sources, a power system, a power market, and the user;
define a cost function; and
determine an amount of power supplied from each energy source of the set of energy sources according to the set of inputs and the cost function.

11. The system of claim 10, wherein the set of inputs comprises a real-time locational marginal pricing (“LMP”) for each energy source of the set of energy sources, a forecasted LMP for each energy source at a time point, a load consumption history for each energy source, a LMP price history for each energy source, a real-time user's power consumption, a forecasted user's power consumption at a time point, a power consumption history for the user, a user's power quality range, or a set of constraints.

12. The system of claim 11, wherein the set of constraints comprises a line capacity for each feeder of a set of feeders, a ramp rate limit for each energy source, a demand tariff for each energy source, a peak demand for each energy source, or a market rule, wherein each feeder of the set of feeders is configured to be coupled to an energy source of the set of energy sources.

13. The system of claim 10, further comprising an energy routing module coupled to the control module, wherein the energy routing module is configured to control the power supplied to the user such that each energy source supplies the amount determined.

14. The system of claim 13, wherein the control module is further configured to generate a set of commands instructing the energy routing module to control the power flow among the set of energy sources and the user.

15. The system of claim 10, wherein the control module is further configured to monitor a phase angle difference between two adjacent feeders of a set of feeders, and wherein each feeder of the set of feeders is coupled to an energy source of the set of energy sources.

16. The system of claim 15, wherein the control module is further configured to determine a second set of energy sources of the first set of energy sources when the phase angle difference exceeds a predetermined value.

17. The system of claim 13, wherein the control module is further configured to monitor a current supplied to the user.

18. The system of claim 17, wherein the energy routing module is further configured to disconnect the user when the current exceeds a predetermined value.

19. The system of claim 13, wherein the energy routing module comprises a set of switches, and the control module is further configured to generate a set of switching signals to regulate the switches.

20. An apparatus for providing energy arbitrage for a user, comprising:
a processor, and
memory coupled to the processor, wherein the memory stores a set of instructions configured to cause the processor to:
describe the user, a power system, a power market, a set of energy sources, the user receiving power from the power system and participating in the power market;
define a cost function; and
determine an amount of power provided by each energy source of the set of energy sources to the user at a time point, wherein a Locational Marginal Price (“LMP”) of each of the set of energy sources is compared such that the user's energy cost is reduced.
